(19) United States
(12) Patent Application Publication
(10) Pub. No.: US 2026/0187149 A1
(43) Pub. Date: Jul. 2, 2026

(54) INTER-INCIDENT RELATIONSHIP GRAPH CONSTRUCTION DEVICE, INTER-INCIDENT RELATIONSHIP GRAPH CONSTRUCTION METHOD, AND RECORDING MEDIUM

(71) Applicant: NEC Corporation, Minato-ku, Tokyo (JP)

(72) Inventors: Takuya KAWADA, Tokyo (JP); Kosuke Akimoto, Tokyo (JP)

(73) Assignee: NEC Corporation, Minato-ku, Tokyo (JP)

(21) Appl. No.: 18/286,281

(22) PCT Filed: Jun. 14, 2023
(86) PCT No.: PCT/JP2023/022036

§ 371 Date: Oct. 10, 2023

(51) Int. Cl. G06F 16/901

(52) U.S. Cl. CPC G06F 16/9024

(57) ABSTRACT

In an inter-incident relationship graph construction device, an acquisition means acquires a plurality of pieces of incident data from a text set. A graph construction means constructs a graph by using nodes and edges with respect to pairs of pieces of incident data having a desired relationship among the plurality of pieces of incident data. A relationship generation means generates nodes corresponding to succeeding cases of respective nodes by a machine learning mode with respect to the respective nodes in the graph constructed by the graph construction means. A graph connection means connects nodes of each pair having the desired relationship among pairs of the respective nodes in the graph constructed by the graph construction means and respective generated nodes. The inter-incident relationship graph construction device can assist a user in decision making by constructing graph.

### TECHNICAL FIELD

The present disclosure relates to constructing of an inter-incident relationship graph.

### BACKGROUND ART

Recent years, knowledge graphs expressing knowledge of various fields have been developed and utilized. Non-Patent Document 1 proposes a language model which determines a presence or absence of a causal relationship for any two sentences extracted from a document set. Also, Non-Patent Document 2 describes a method for generating a knowledge graph using a large language model (LLM (Large Language Model)).

### PRECEDING TECHNICAL REFERENCES

### Patent Document

[Non-Patent Document 1] Khetan Vivek, Ramnani Roshni, Anand Mayuresh, Sengupta Shubhashis, Fano Andrew E. “Causal BERT: Language models for causality detection between incidents expressed in text,” 2020.
[Non-Patent Document 2] West Peter, Bhagavatula Chandra, Hessel Jack, Hwang Jena D., Jiang Liwei, Bras Ronan Le, Lu Ximing, Welleck Sean, Choi Yejin. “Symbolic Knowledge Distillation: from General Language Models to Commonsense Models,” 2021.

### SUMMARY

### Problem to be Solved by the Invention

However, there is also a problem in that it is difficult to construct a consistent and effective graph according to Non-Patent Document 1 and Non-Patent Document 2.

It is one object of the present disclosure to provide an inter-incident relationship graph construction device capable of constructing a consistent and effective graph structure using an LLM.

### Means for Solving the Problem

According to an example aspect of the present disclosure, there is provided an inter-incident relationship graph construction device comprising:
an acquisition means configured to acquire a plurality of pieces of incident data from a text set;
a graph construction means configured to construct a graph by using nodes and edges with respect to pairs of pieces of incident data having a desired relationship among the plurality of pieces of incident data;
a relationship generation means configured to generate nodes corresponding to succeeding cases of respective nodes by a machine learning mode with respect to the respective nodes in the graph constructed by the graph construction means; and
a graph connection means configured to connect nodes of each pair having the desired relationship among pairs of the respective nodes in the graph constructed by the graph construction means and respective generated nodes.

According to another example aspect of the present disclosure, there is provided an inter-incident relationship graph construction method performed by a computer, the method including:
acquiring a plurality of pieces of incident data from a text set;
constructing a graph by using nodes and edges with respect to pairs of pieces of incident data having a desired relationship among the plurality of pieces of incident data;
generating nodes corresponding to succeeding cases of respective nodes by a machine learning mode with respect to the respective nodes in the graph; and
connecting nodes of each pair having the desired relationship among pairs of the respective nodes in the graph and respective generated nodes.

According to a further example aspect of the present disclosure, there is provided a recording medium storing a program, the program causing a computer to perform a process including:
acquiring a plurality of pieces of incident data from a text set;
constructing a graph by using nodes and edges with respect to pairs of pieces of incident data having a desired relationship among the plurality of pieces of incident data;
generating nodes corresponding to succeeding cases of respective nodes by a machine learning mode with respect to the respective nodes in the graph; and
connecting nodes of each pair having the desired relationship among pairs of the respective nodes in the graph and respective generated nodes.

### Effect of the Invention

According to the present disclosure, it becomes possible to construct valid graphs retaining consistency and using an LLM.

### BRIEF DESCRIPTION OF THE DRAWINGS

FIG. 1 illustrates an overall configuration of an inter-incident relationship graph construction system.

FIG. 2 illustrates a block diagram illustrating a hardware configuration of an inter-incident relationship graph construction device.

FIG. 3 is a block diagram illustrating a functional configuration of the inter-incident relationship graph construction device.

FIG. 4 is a diagram for explaining a method for constructing a graph.

FIG. 5 is a diagram for explaining the method for constructing the graph.

FIG. 6 is a flowchart of a graph construction process by the inter-incident relationship graph construction device.

FIG. 7 illustrates an example of input data.

FIG. 8 illustrates a display example of an inter-incident relationship graph.

FIG. 9 is a block diagram illustrating a functional configuration of an inter-incident relationship graph construction device of a second example embodiment.

FIG. 10 is a flowchart of a process by the inter-incident relationship graph construction device of a second example embodiment.

### EXAMPLE EMBODIMENTS

In the following, example embodiments will be described with reference to the accompanying drawings.

### First Example Embodiment

To facilitate understanding of a first example embodiment, the background and problems underlying a premise will be explained in detail. In a case where a company formulates a business strategy and makes a decision, it may use a variety of information to make a prediction. For instance, a strategy consultant predicts trends in an industry, predicts the future, predicts needs, and proposes a strategic direction. The strategy consultant constructs a megatrend hypothesis to make the above predictions. Here, the “megatrend hypothesis” is a broad graph structure in which incidents (currently occurring and possible future incidents) and needs in an industry are linked in a chain manner, mainly by a causal relationship. This graph structure is constructed using a trend in the industry as a starting point. Moreover, the graph structure needs to satisfy the following requirements as much as possible: there exist many nodes between the starting point and an end point, the reliability of the information is ensured, a variety of causal relationships are included, and the like. The megatrend hypothesis is constructed mainly by hand, which is time and labor intensive.

Even using Non-Patent Document 1 and Non-Patent Document 2, the distance from the starting point to the end point is far, and it is difficult to construct a consistent graph. Moreover, it is also difficult to construct a graph ensuring the reliability of the causal relationship or a graph containing a variety of causal relationships even, by Non-Patent Document 1 and Non-Patent Document 2.

### [Overall Configuration]

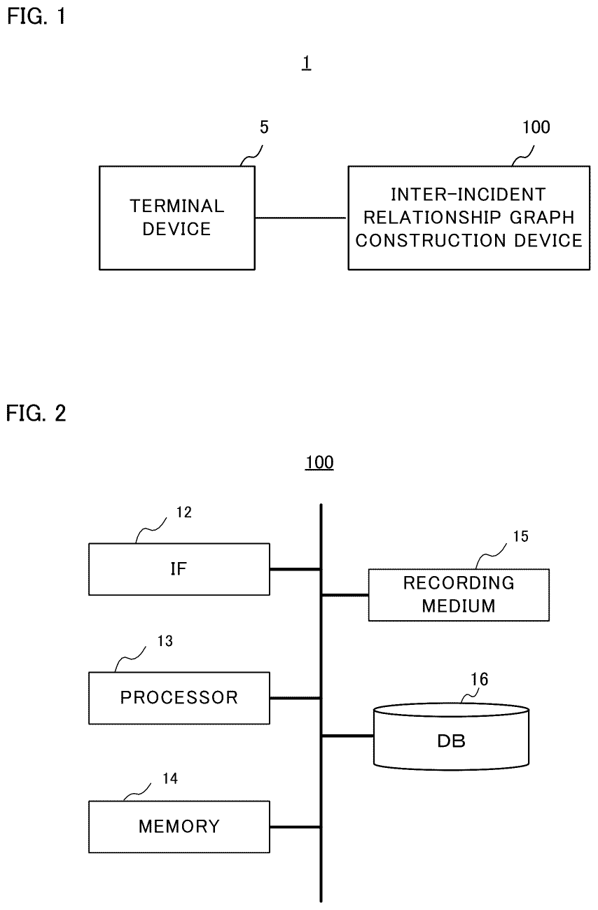

FIG. 1 illustrates an overall configuration of an inter-incident relationship graph construction system according to the first example embodiment. Note that an inter-incident relationship graph refers to a graph related to the inter-incident relationship. In this example embodiment, as a relationship between the incidents, the causal relationship will be described as an example.

An incident relationship graph construction system 1 includes a user terminal device 5 and an incident relationship graph construction device 100. A user operates the terminal device 5 and sends a generation request for the inter-incident relationship graph to the inter-incident relationship graph construction device 100. The generation request includes keywords concerning the inter-incident relationship graph desired to generate. The incident relationship graph construction device 100 generates an incident relationship graph based on a document set (text set) prepared in advance based on the generation request of a user, and sends the incident relationship graph to the terminal device 5 of the user.

### [Hardware Configuration]

FIG. 2 is a block diagram illustrating a hardware configuration of the inter-incident relationship graph construction device 100. As illustrated, the incident relationship graph construction device 100 includes an interface (IF) 12, a processor 13, a memory 14, a recording medium 15, and a database (DB) 16.

By communicating with an external device, the IF 12 obtains a generation request of the inter-incident relationship graph which is input by the user. Moreover, the IF 12 sends the inter-incident relationship graph generated by the inter-incident relationship graph construction device 100 to an external device. Specifically, in a case where the user sends the generation request of the incident relationship graph to the incident relationship graph construction device 100 by using the terminal device 5, the incident relationship graph construction device 100 receives the generation request through the IF 12 and sends the generated incident relationship graph to the terminal device 5 of the user through the IF 12.

The processor 13 is a computer such as a CPU (Central Processing Unit), and controls the entire incident relationship graph construction device 100 by executing programs prepared in advance. Specifically, the processor 13 may be a CPU, a GPU (Graphics Processing Unit), a DSP (Digital Signal Processor), a MPU

(Micro Processing Unit), a FPU (Floating Point number Processing Unit), a PPU (Physics Processing Unit), a TPU (Tensor Processing Unit), a quantum processor, a microcontroller, or a combination thereof. In detail, the processor 13 executes a process of constructing the inter-incident relationship graph.

The memory 14 is formed by a ROM (Read Only Memory), a RAM (Random Access Memory), and the like. The memory 14 stores various programs executed by the processor 13. Moreover, the memory 14 is used as a working memory during various processes performed by the processor 13.

The recording medium 15 is a non-volatile and non-transitory recording medium such as a disk-shaped recording medium, or a semiconductor memory, and is formed to be removable from the inter-incident relationship graph construction device 100. The recording medium 15 records various programs executed by the processor 13. When the incident relationship graph construction device 100 executes various kinds of processes, the programs recorded on the recording medium 15 are loaded into the memory 14 and executed by the processor 13.

The DB 16 stores the document set used in a case of constructing the inter-incident relationship graph. For instance, the incident relationship graph construction device 100 may create a document set based on a URL or text data of the latest news or article input by the user, and store the created document set in the DB 16. The incident relationship graph construction device 100 may crawl Web sites, create a document set from documents on the Web sites, and store the document set in the DB 16.

Moreover, the DB 16 may also store a machine-learning model or the like used in a graph construction process described below. The DB 16 may store graph data generated by the inter-incident relationship graph construction device 100 as a graph database.

In addition to the above, the inter-incident relationship graph construction device 100 may include a display device such as a liquid crystal display or a projector, and an input device such as a keyboard or a mouse. These display device and input device are used, for instance, by an administrator of the inter-incident relationship graph construction device 100 to perform the necessary management.

### [Functional Configuration]

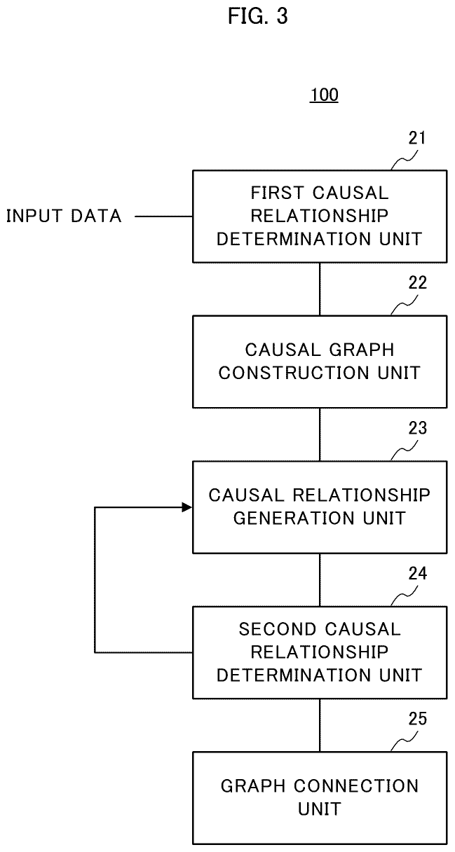

FIG. 3 is a block diagram illustrating a functional configuration of the inter-incident relationship graph construction device 100. The inter-incident relationship graph construction device 100 functionally includes a first causal relationship determination unit 21, a causal graph construction unit 22, a causal relationship generation unit 23, a second causal relationship determination unit 24, and a graph connection unit 25.

The user enters a keyword, a domain name, or the like related to the incident-device graph to be generated into the incident-relationship graph construction device 100.

The first causal relationship determination unit 21 acquires a predetermined document set from the DB 16 based on the keyword or the domain name entered by the user. Next, the first causal relationship determination unit 21 extracts an incident from each document included in the predetermined document set. Here, the incident corresponds to a text which describes an incident which has already occurred in the present, a possible incident that may occur in the future, or the like. Note that the text describing the incident may be statement, phrases, or sentences. After that, for each pair of incidents, the first causal relationship determination unit 21 determines the presence or absence of a causal relationship by using a causal relationship extraction model. For instance, the first causal relationship determination unit 21 determines that each pair of incidents, in which a score output from the causal relationship extraction model is equal to or more than a predetermined threshold value, has the causal relationship. The first causal relationship determination unit 21 outputs a determination result to the causal graph construction unit 22.

Note that a causal relationship extraction model is a model for determining the presence or absence of the causal relationship for any two steps extracted from the document set, for instance, and may be created using BERT (Bidirectional Encoder Representations from Transformers) described in Non-Patent Document 1.

Moreover, a technology of a natural language process for determining the existence or absence of the causal relationship for any two incidents is not limited to the technology using a language model such as the BERT. The method for determining the causal relationship may be any rule-based algorithm, any machine learning algorithm, or the like.

The causal graph construction unit 22 acquires a determination result from the first causal relationship determination unit 21. The causal graph construction unit 22 extracts a pair of incidents having the causal relationship from the determination result, and constructs a graph. In detail, the causal graph construction unit 22 constructs a directed graph by representing each extracted incident as a node and connecting between nodes having the causal relationship with edges having directionality. The causal graph construction unit 22 outputs the constructed graph to the causal relationship generation unit 23.

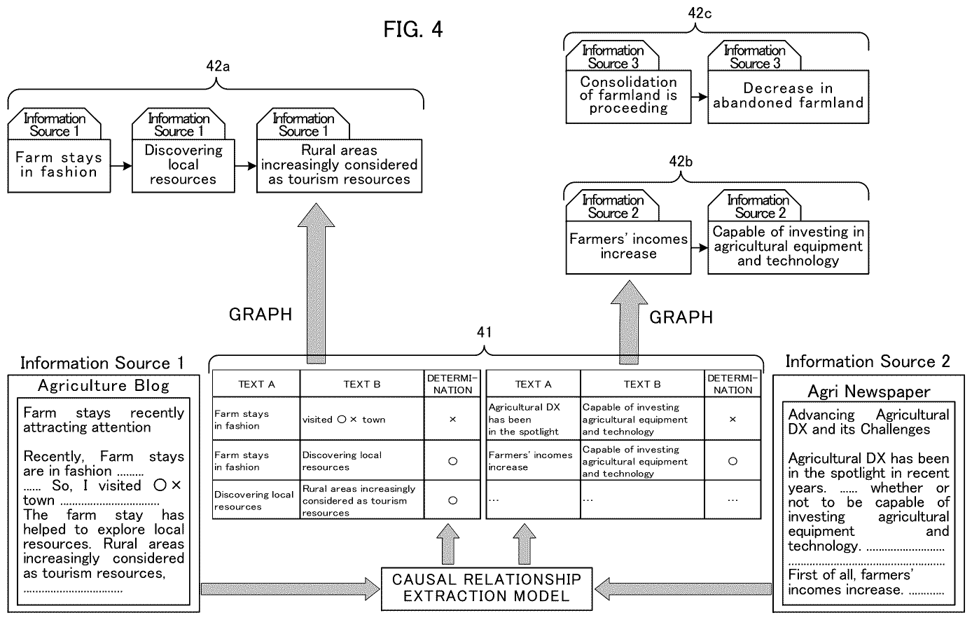

FIG. 4 is a diagram illustrating a method for constructing a graph. In FIG. 4, first, the first causal relationship determination unit 21 extracts each pair of incidents from information source 1 and information source 2 included in the document set, and determines whether or not there is a causal relationship for each pair of incidents. A determination result 41 in FIG. 4 indicates a result from determining a presence or absence of the causal relationship for each pair of incidents extracted from the information source 1 and the information source 2.

Next, the causal graph construction unit 22 constructs graphs 42a, 42b and 42c based on the determination result 41. The graphs 42a, 42b and 42c represent the respective incidents as rectangular nodes. Moreover, the graphs 42a, 42b and 42c represent the causal relationship between nodes by illustrating edges as arrows in one direction. Note that in the graphs 42a, 42b and 42c, a source of each arrow corresponds to a cause (CAUSE), and a destination of each arrow corresponds to an effect (EFFECT). Hereinafter, a node corresponding to CAUSE is also referred to as a “preceding case” and a node corresponding to EFFECT as a “succeeding case”. Note that the causal graph construction unit 22 connects the preceding case and the succeeding case in a case where both nodes are synonymous. Whether or not the preceding case and the succeeding case are synonymous can be determined using a synonymity determination model which determines a synonymity of a pre-trained document pair.

In the above method, since documents and the like on Web sites are used as information sources, each origin of information is clear and various causal relationships can be comprehensively extracted. However, with the above method, it is difficult to capture causal relationships when topics differ slightly among the information sources, thus resulting in a construction of a disconnected graph with a plurality of components. For instance, in FIG. 4, the first causal relationship determination unit 21 determines that there is no causal relationship between an incident extracted from the information source 1, and an incident extracted from the information source 2. Therefore, in FIG. 4, disconnected graphs including the graphs 42a and 42b are generated.

Returning to FIG. 3, the causal relationship generation unit 23 acquires the graph from the causal graph construction unit 22. Next, the causal relationship generation unit 23 generates the node of a new succeeding case in which each node included in the graph is the preceding case by using a large language model. The causal relationship generation unit 23 outputs the graph including a new succeeding case (hereinafter, referred to as a “node addition graph”) to the second causal relationship determination unit 24.

Note that the large language model (also, simply referred to as a “language model”) is a machine learning model which learns a relationship between words in a sentence and generates, from a subject string, a relevant string which is related to the subject string. By using a language model which has learned a variety of contexts and sentences, it is possible to generate the relevant string of a reasonable content related to the subject string.

For instance, a case in which the language model is used in a question and answer will be described. The language model accepts an input of a question “What is Japan like?” as the subject string. As the answer to that question, the language model generates a string such as “Japan is in an island country in the northern hemisphere . . . ”.

The learning method of the language model is not particularly limited, but as an example, the language model may be trained to output at least one sentence containing the input string. For instance, the language model corresponds to a GPT (Generative Pretrained Transformer) for outputting a sentence containing a string which is input by predicting a probable string following the input string. Besides this, as another instance, the language model may be any of a T5 (Text-to-Text Transfer Transformer), a BERT (Bidirectional Encoder Representations from Transformers), a ROBERTa (Robustly optimized BERT approach), an ELECTRA (Efficiently Learning an Encoder that Classifies Token Replacements Accurately), and the like.

Moreover, the string generated by the language model is not limited to a natural language. The language model may output, for instance, an artificial language (a mathematical expression, a program source code, or the like) to a string which is input in the natural language. For instance, the language model accepts a subject string with a question “How to retrieve data containing a specific string from the database?”. The language model may output the program source code for performing a database process. Alternatively, the language model may output a natural language corresponding to a string entered in an artificial language.

Moreover, the content generated by the language model is not limited to the string. The language model may generate, for instance, image data, video data, audio data, or any of other data formats corresponding to the input string.

In this example embodiment, a large language model is a model for generating a new incident which has the causal relationship to an existing incident, and can be created using the above-described GPT or a Critic model. The user can generate a new succeeding case by presenting an instruction, called a “prompt” to the large language model. The prompt includes the “instruction” indicating desired information and a “sample” to serve as a good example as needed.

The second causal relationship determination unit 24 acquires the node addition graph from the causal relationship generation unit 23. The second causal relationship determination unit 24 determines the presence or absence of the causal relationship using the causal relationship extraction model described above for each pair of the nodes for a node of a new succeeding case and respective nodes included in the node addition graph. Note that the second causal relationship determination unit 24 may determine the presence or absence of the causal relationship for each of pairs with respect to all nodes included in the node addition graph.

In a case where it is determined that there is a pair of nodes having a causal relationship, the second causal relationship determination unit 24 outputs a determination result to the graph connection unit 25. The graph connection unit 25 connects nodes having the causal relationship as a pair with the edge based on the determination result which is input from the second causal relationship determination unit 24.

On the other hand, in a case where it is determined that there is no pair of nodes having a causal relationship, the second causal relationship determination unit 24 outputs the determination result to the causal relationship generation unit 23. The causal relationship generation unit 23 uses the large language model again and generates a node of a new succeeding case as each node included in the node addition graph is regarded as the preceding case. Next, the causal relationship generation unit 23 outputs a graph including the new succeeding node (hereinafter, also referred to as a “node re-addition graph”) to the second causal relationship determination unit 24. The second causal relationship determination unit 24 determines the presence or absence of the causal relationship using the causal relationship extraction model described above for each pair of the nodes of the new succeeding case which the causal relationship generation unit 23 generates again and the nodes included in the node re-addition graph. The second causal relationship determination unit 24 outputs the determination result to the graph connection unit 25 when it is determined that there is a pair of nodes having the causal relationship, and the above process is repeated when it is determined that there is no pair of nodes having the causal relationship. The above process is repeated until it is determined that there is the pair of nodes having the causal relationship or until the process reaches a predetermined number of times.

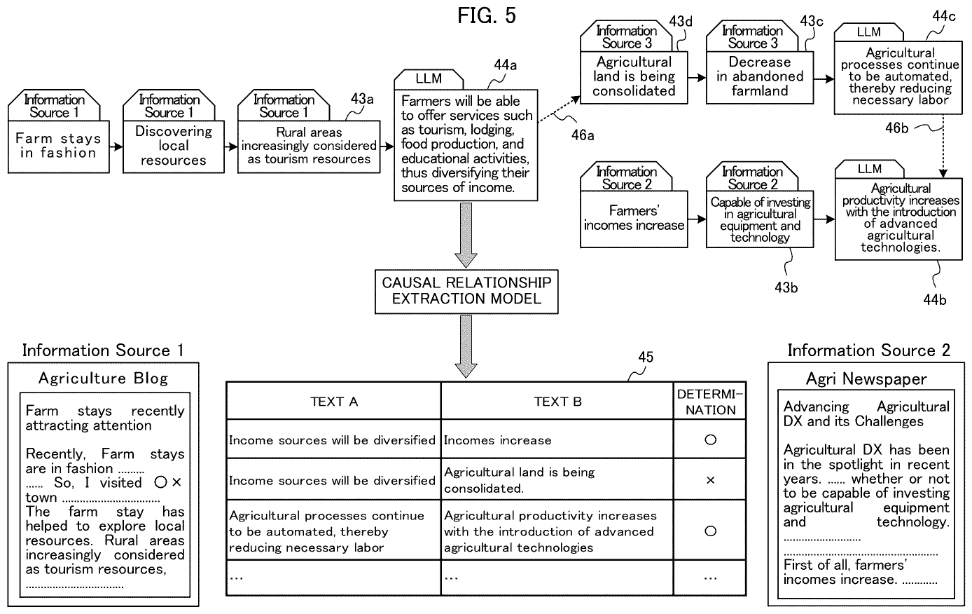

FIG. 5 is a diagram illustrating a method for constructing the graph. In FIG. 5, the causal relationship generation unit 23 regards that nodes 43a, 43b, and 43c are the preceding cases, and generates nodes 44a, 44b, and 44c of the new succeeding cases. Note that the causal relationship generation unit 23 generates a node of the new succeeding case for each node included in the graph but for convenience of illustration, only a portion thereof are illustrated.

Next, the second causal relationship determination unit 24 determines the presence or absence of the causal relationship for each pair of the node of the new succeeding case and each of the nodes included in the graph, and generates a determination result 45. In FIG. 5, the second causal relationship determination unit 24 determines that there is the causal relationship between the node 44a and a node 43d and there is the causal relationship between the node 44b and the node 44c. Next, the graph connection unit 25 connects nodes having the causal relationship as pair with the edge. The graph connection unit 25 connects between the node 44a and the node 43d by a dashed arrow 46a, and connects between the node 44b and the node 44c by a dashed arrow 46b.

By the above method, it is possible to complement among the graph 42a, 42b, and 42c constructed in FIG. 4, and it is possible to construct a graph in which a distance from an origin node to an end node is far and which is consistent.

In the above configuration, the first causal relationship determination unit 21 corresponds to an example of an acquisition means, the causal graph construction unit 22 corresponds to an example of a graph construction means, the causal relationship generation unit 23 corresponds to an example of a relationship generation means, and the second causal relationship determination unit 24 and the graph connection unit 25 correspond to examples of a graph connection means.

### [Inter-Incident Relationship Graph Construction Process]

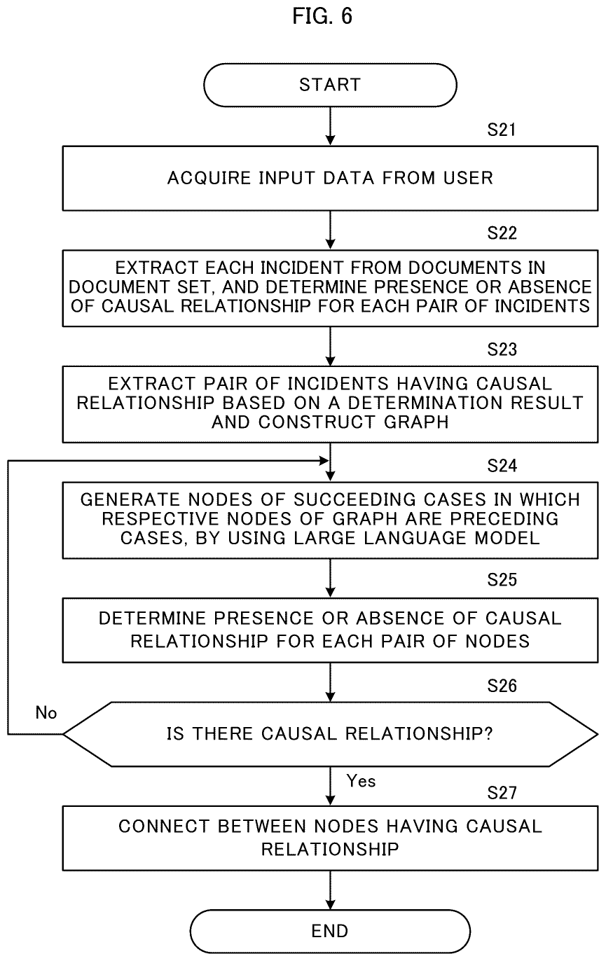

FIG. 6 is a flowchart of an inter-incident relationship graph construction process performed by the inter-incident relationship graph construction device 100. This process is realized by the processor 13 illustrated in FIG. 2 which executes a program prepared in advance and operates as each element depicted in FIG. 3.

First, the incident relationship graph construction device 100 obtains a keyword, a domain name, and the like concerning the incident relationship graph which are input by the user (step S21). Next, the first causal relationship determination unit 21 acquires a predetermined document set from the DB 16 based on the keyword or the domain name. Subsequently, the first causal relationship determination unit 21 extracts each incident from respective documents included in the predetermined document set, and determines the presence or absence of the causal relationship for each of a plurality of pairs of incidents by using the causal relationship extraction model (step S22). The first causal relationship determination unit 21 outputs a determination result to the causal graph construction unit 22. After that, the causal graph construction part 22 extracts each pair of incidents having the causal relationship based on the determination result, and constructs a graph (step S23). The causal graph construction unit 22 outputs the constructed graph to the causal relationship generation unit 23.

Next, the causal relationship generation unit 23 uses the large language model and generates nodes of a new succeeding case in which each node included in the graph is the preceding case (step S24). The causal relationship generation unit 23 outputs a node addition graph to the second causal relationship determination unit 24. Next, the second causal relationship determination unit 24 determines the presence or absence of the causal relationship for each pair of a node being the new succeeding case and each node included in the node addition graph by using the causal relationship extraction model described above (step S25). Subsequently, when the second causal relationship determination unit 24 determines that there is no pair of nodes having the causal relationship (step S26: No), this process returns to step S24. On the other hand, when determining that there is a pair of nodes having the causal relationship (step S26: Yes), the second causal relationship determination unit 24 outputs a determination result to the graph connection unit 25. The graph connection unit 25 connects nodes of a pair having the causality by the edge based on the determination result (step S27). After that, the inter-incident relationship graph construction process is terminated.

### MODIFICATION

### Modification 1

In the above-described example embodiment, the graph is constructed based on the causal relationship between the incidents; however, the relationship between the incidents used to construct the graph is not limited to the causal relationship. For instance, it may be a relationship such as a sequential relationship in which the preceding case and the succeeding case cannot be replaced.

### Modification 2

The inter-incident relationship graph construction device of the above-described example embodiment may be applied to in constructing of the inter-incident relationship graph concerning a medical care or a health care (healthcare). It is possible for the inter-incident graph construction device to organize the latest medical information by adding new medical information to the existing inter-incident relationship graph.

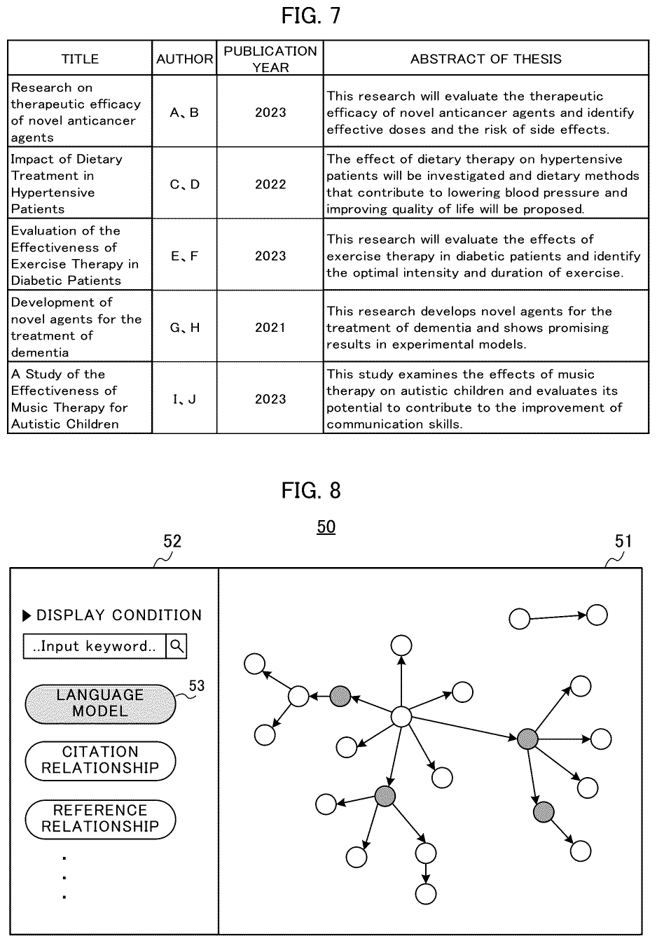

For instance, the user input URL or text data of the latest news or article concerning the health care into the inter-incident relational graph construction device and requests to generate a new inter-incident relational graph. FIG. 7 illustrates an example of input information concerning the medical care. The incident relationship graph construction device newly generates an incident relationship graph based on a document and text data on a linked Web site. Next, the incident relationship graph construction device determines whether there is the causal relationship between each node of the newly generated incident relationship graph and each node of an existing incident relationship graph stored in the DB 16. By connecting nodes having the causal relationship as a pair by the edge, the incident relationship graph construction device adds the newly generated incident relationship graph to the existing incident relationship graph.

Note that there is no causal relationship between each node of the newly generated incident relationship graph and each node of the existing incident relationship graph, the inter-incident relationship graph construction device may generate a node of the succeeding case, and determine the causal relationship again.

FIG. 8 illustrates a display example of the inter-incident relationship graph output by the inter-incident relationship graph construction device. The display screen 50 includes a graph display portion 51 and a search portion 52. The graph display portion 51 is an area for displaying the relationship graph between incidents. The search portion 52 is an area for specifying a search condition. By specifying the search condition, the user can search information related to a specific keyword or topic from the incident relationship graph. For instance, in FIG. 8, a language model button 53 is selected. Upon selecting the language model button 53 by the user, the nodes generated by the large language model are displayed in a different manner (in gray) from other nodes. A display form for the search result is not limited to the above; for instance, only a graph portion generated by the large language model may be displayed. Moreover, the user may change a display form corresponding to the graph portion by selecting a type of the directed edge such as a citation relationship or a reference relationship, or the corresponding graph portion alone may be displayed.

As described above, by adding new medical information to the existing inter-incident relationship graph, it is possible for the user to organize the latest medical information, and it is possible to expand the inter-incident relationship while continually updating the medical information.

### Second Example Embodiment

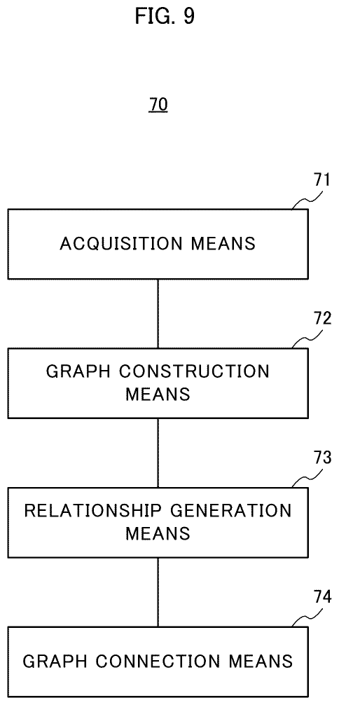

FIG. 9 is a block diagram illustrating a functional configuration of an inter-incident relationship graph construction device according to a second example embodiment. An inter-incident relationship graph construction device 70 includes an acquisition means 71, a graph construction means 72, a relationship generation means 73, and a graph connection means 74.

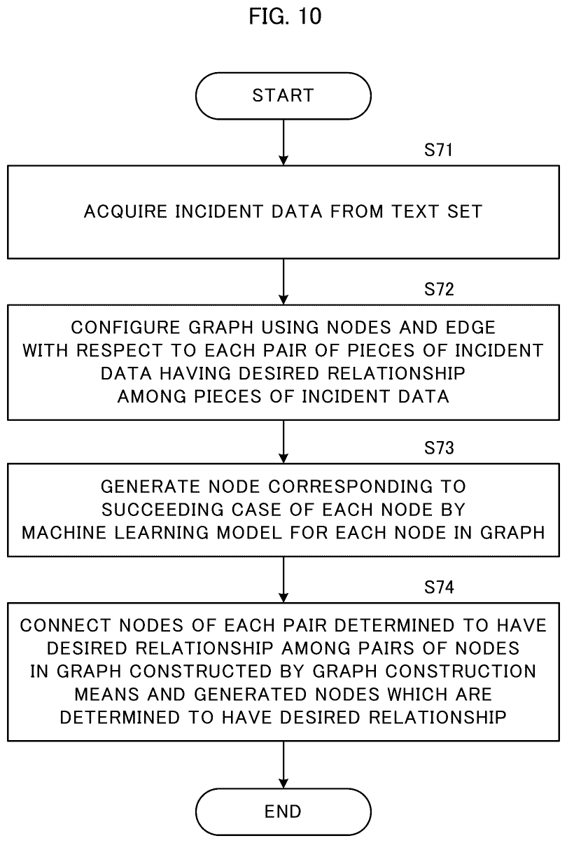

FIG. 10 is a flowchart of a process performed by the inter-incident relationship graph construction device 70 according to the second example embodiment. The acquisition means 71 acquires incident data from a test set (step S71). The graph construction means 72 constructs a graph using nodes and an edge with respect to each pair of pieces of incident data having a desired relationship among the pieces of incident data (step S72). The relationship generation means 73 generates a node corresponding to the succeeding case of each node by the machine learning model for each node in the graph constructed by the graph construction means (step S73). The graph connection means 74 connects nodes of each pair determined to have the desired relationship, among pairs of the nodes in the graph constructed by the graph construction means and the generated nodes which are determined to have the desired relationship (step S74).

According to the inter-incident relationship graph construction device 70 of the second example embodiment, it is possible to construct a valid graph in which consistency is maintained using an LLM. Accordingly, by the inter-incident relationship graph construction device 70, it is possible to assist the user in making decisions based on a megatrend hypothesis.

A part or all of the example embodiments described above may also be described as the following supplementary notes, but not limited thereto.

### Supplementary Note 1

An inter-incident relationship graph construction device comprising:
an acquisition means configured to acquire a plurality of pieces of incident data from a text set;
a graph construction means configured to construct a graph by using nodes and edges with respect to pairs of pieces of incident data having a desired relationship among the plurality of pieces of incident data;
a relationship generation means configured to generate nodes corresponding to succeeding cases of respective nodes by a machine learning mode with respect to the respective nodes in the graph constructed by the graph construction means; and
a graph connection means configured to connect nodes of each pair having the desired relationship among pairs of the respective nodes in the graph constructed by the graph construction means and respective generated nodes.

### Supplementary Note 2

The inter-incident relationship graph construction device according to supplementary note 1, wherein when there is no desired relationship in the pairs of the respective nodes in the graph constructed by the graph construction means and the respective generated nodes,
the relationship generation means further generates additional nodes corresponding to the succeeding cases of respective nodes with respect to the respective nodes in the graph constructed by the graph construction means or the respective generated nodes.

### Supplementary Note 3

The inter-incident relationship graph construction device according to supplementary note 1, wherein the relationship generation means generates additional nodes corresponding to the succeeding cases of respective nodes with respect to the respective nodes in the graph constructed by the graph construction means or the respective generated nodes until a count of generating nodes exceeds a predetermined number of times.

### Supplementary Note 4

The inter-incident relationship graph construction device according to supplementary note 1, further comprising a storage means configured to store an existing graph,
wherein the graph connection means expands the existing graph by connecting nodes of each pair determined to have a desired relationship among pairs between respective nodes in the existing graph and the respective nodes in the graph constructed by the graph construction means.

### Supplementary Note 5

The inter-incident relationship graph construction device according to supplementary note 1, further comprising
a display means configured to display the graph which the graph connection means has generated by connecting nodes of the pair; and
a reception means configured to receive an instruction for a display form from a user,
wherein the display means switches the display form of the graph based on the instruction for the display form which is input by the user.

### Supplementary Note 6

The inter-incident relationship graph construction device according to supplementary note 5, wherein the instruction for the display form includes an instruction for visualizing only a predetermined node and a predetermined edge or an instruction for differing the display form of the predetermined node and the predetermined edge.

### Supplementary Note 7

The inter-incident relationship graph construction device according to supplementary note 4 or 5, wherein
the text set is a text set concerning medical information; and
the graph constructed by the graph construction means and the graph updated by the graph connection means include an inter-incident relationship concerning medical information.

### Supplementary Note 8

An inter-incident relationship graph construction method performed by a computer, the method comprising:
acquiring a plurality of pieces of incident data from a text set;
constructing a graph by using nodes and edges with respect to pairs of pieces of incident data having a desired relationship among the plurality of pieces of incident data;
generating nodes corresponding to succeeding cases of respective nodes by a machine learning mode with respect to the respective nodes in the graph; and
connecting nodes of each pair having the desired relationship among pairs of the respective nodes in the graph and respective generated nodes.

### Supplementary Note 9

A recording medium storing a program, the program causing a computer to perform a process comprising:
acquiring a plurality of pieces of incident data from a text set;
constructing a graph by using nodes and edges with respect to pairs of pieces of incident data having a desired relationship among the plurality of pieces of incident data;
generating nodes corresponding to succeeding cases of respective nodes by a machine learning mode with respect to the respective nodes in the graph; and
connecting nodes of each pair having the desired relationship among pairs of the respective nodes in the graph and respective generated nodes.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

DESCRIPTION OF SYMBOLS

| | |
|---|---|
| 1 | Inter-incident relationship graph construction |
| | system |
| 5 | Terminal device |
| 21 | First causal relationship determination unit |
| 22 | Causal graph construction unit |
| 23 | Causal relationship determination unit |
| 24 | Second causal relationship determination unit |
| 25 | Graph connection unit |
| 100 | Inter-incident relationship graph construction |
| | device |

What is claimed is:

1. An inter-incident relationship graph construction device comprising:
a memory storing instructions; and
one or more processors configured to execute the instructions to:
acquire a plurality of pieces of incident data from a text set;
construct a graph by using nodes and edges with respect to pairs of pieces of incident data having a desired relationship among the plurality of pieces of incident data;
generate nodes corresponding to succeeding cases of respective nodes by a machine learning mode with respect to the respective nodes in the graph; and
connect nodes of each pair having the desired relationship among pairs of the respective nodes in the graph-constructed by the graph construction means and respective generated nodes.

2. The inter-incident relationship graph construction device according to claim 1, wherein when there is no desired relationship in the pairs of the respective nodes in the graph and the respective generated nodes,
the processor further generates additional nodes corresponding to the succeeding cases of respective nodes with respect to the respective nodes in the graph or the respective generated nodes.

3. The inter-incident relationship graph construction device according to claim 1, wherein the processor generates additional nodes corresponding to the succeeding cases of respective nodes with respect to the respective nodes in the graph or the respective generated nodes until a count of generating nodes exceeds a predetermined number of times.

4. The inter-incident relationship graph construction device according to claim 1, wherein the processor is further configured to store an existing graph in the memory,
wherein the processor expands the existing graph by connecting nodes of each pair determined to have a desired relationship among pairs between respective nodes in the existing graph and the respective nodes in the graph constructed by using the nodes and the edges.

5. The inter-incident relationship graph construction device according to claim 1, wherein the processor is further configured to
display the graph generated by connecting nodes of the pair; and
receive an instruction for a display form from a user,
wherein the processor switches the display form of the graph based on the instruction for the display form which is input by the user.

6. The inter-incident relationship graph construction device according to claim 5, wherein the instruction for the display form includes an instruction for visualizing only a predetermined node and a predetermined edge or an instruction for differing the display form of the predetermined node and the predetermined edge.

7. The inter-incident relationship graph construction device according to claim 4, wherein
the text set is a text set concerning medical information; and
the graph constructed by using the nodes and the edges and the graph updated by expanding the existing graph include an inter-incident relationship concerning medical information.

8. An inter-incident relationship graph construction method performed by a computer, the method comprising:
acquiring a plurality of pieces of incident data from a text set;
constructing a graph by using nodes and edges with respect to pairs of pieces of incident data having a desired relationship among the plurality of pieces of incident data;
generating nodes corresponding to succeeding cases of respective nodes by a machine learning mode with respect to the respective nodes in the graph; and
connecting nodes of each pair having the desired relationship among pairs of the respective nodes in the graph and respective generated nodes.

9. A non-transitory computer-readable recording medium storing a program, the program causing a computer to perform a process comprising:
acquiring a plurality of pieces of incident data from a text set;
constructing a graph by using nodes and edges with respect to pairs of pieces of incident data having a desired relationship among the plurality of pieces of incident data;
generating nodes corresponding to succeeding cases of respective nodes by a machine learning mode with respect to the respective nodes in the graph; and
connecting nodes of each pair having the desired relationship among pairs of the respective nodes in the graph and respective generated nodes.
